(19) United States
(12) Patent Application Publication
(10) Pub. No.: US 2008/0172217 A1
(43) Pub. Date: Jul. 17, 2008

(54) Medium storing model creation program, model creation apparatus and model creation method

(75) Inventor: Rafael Kazumiti Morizawa, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/986,999

(22) Filed: Nov. 28, 2007

(30) Foreign Application Priority Data
Jan. 15, 2007 (JP) 2007-005367

(51) Int. Cl. G06G 7/62

(52) U.S. Cl. 703/13

(57) ABSTRACT

There are provided a medium storing a model creation program for creating a model for communicating with an object apparatus to be verified, a model creation apparatus and a model creation method. A medium storing a model creation program for causing a computer to create a model for communicating with an object apparatus to be verified so as to be readable to the computer, wherein the program causes the computer to execute an acquisition step that acquires a first finite state machine expressing the interface specification of the object apparatus to be verified as a finite state machine, a first addition step that adds an error state and a state transition to the error state to the first finite state machine to produce a second finite state machine and sets the transition conditions of the second transition machine according to the set error probability and a conversion step that converts the second finite state machine into a model for communicating with the object apparatus to be verified.

### BACKGROUND OF THE INVENTION

1. Field of the Invention

This invention relates to a medium storing a model creation program for creating a model for communicating with an object apparatus to be verified, or an object apparatus of verification, a model creation apparatus and a model creation method.

2. Description of the Related Art

Verifications of hardware can be roughly classified into “function verifications” and “interface verifications”. The objective of function verifications is to verify that the object hardware to be verified is functioning properly. On the other hand, the objective of interface verifications is to verify that the object hardware to be verified is exchanging properly data and signals with some other piece of hardware. Generally, attention is paid to function verifications of hardware. However, interface verifications are equally important.

Attention is paid to three items listed below when verifying an interface of hardware.

(Verification item 1) Can the interface exchange signals properly in a manner as specified in the applicable specification?

(Verification item 2) Does the interface exchange signals properly, processing exceptional operations that are expected in the applicable specification?

(Verification item 3) Does not the interface fall into an unrecoverable condition due to an exchange of signals not specified in the applicable specification and can it process normal exchanges of signals that are input subsequently?

For ordinary interface verifications, it is sufficient to check the verification item 1 and the verification item 2. However, it is necessary to check the verification item 3 for some special pieces of hardware in addition to the verification item 1 and the verification item 2, although such a sort of hardware does not take a large part. For example, so-called bus bridges belong to such a sort of hardware. Since a bus bridge connects two buses, the buses can no longer communicate with each other once the bus bridge falls in trouble. Therefore, it is necessary to check and see that the bus bridge does not fall into an incommunicable state if a signal pattern that is not specified in the applicable interface specification and hence not expected to appear flows to either bus beside the normal patterns and the abnormal patterns that are specified in the applicable interface specification.

New types of hardware have been and being designed by utilizing the IPs (intellectual properties) that were designed in the past and the IPs that have been procured externally to show a trend of hardware design in recent years. If such is the case, the IP that is reutilized is required to exchange signals with some other piece of hardware in different operation environments. Additionally, the IP that is reutilized may also be required to withstand exchanges of signals that are not normal and abnormal signals that are not expected in operation environments. Then, it is necessary to verify that the hardware does not fall into an unrecoverable condition when it comes to a deadlock, a livelock or the like.

A piece of verifier communication hardware that is adapted to communicate with the object hardware to be verified in order to verify the interface of the object hardware to be verified. FIG. 24 of the accompanying drawings is a schematic block diagram illustrating a typical connection between the object hardware to be verified and the verifier communication hardware. The verifier communication hardware is adapted to input a signal (a test pattern) to the object hardware to be verified and receive a signal output from the object hardware to be verified to the verifier communication hardware. Additionally, the verifier communication hardware can operate both as master and slave relative to the object hardware to be verified.

A verifier communication model (pseudo-master/slave model) can be used to replace the verifier communication hardware that transmits a signal to and receives a signal from the object hardware to be verified as input signal and output signal. The verifier communication model is a model created by describing the verifier communication hardware by means of a hardware description language. Basically, a verifier communication model outputs a signal provided by the applicable interface specification to the object hardware to be verified. Then, it receives the signal output from the object hardware to be verified as a response and outputs a signal that is provided next if the received signal conforms to the specification.

It is possible to do two different types of test as listed below by means of a verifier communication model for the purpose of interface verification of hardware.

(Test technique 1) A test pattern is generated for each use case. With this test technique, it is necessary to check the operation for each use case provided by the interface specification.

(Test technique 2) Test patterns are generated at random.

For these test types, there are two types of test pattern that are input to the interface of the object hardware to be verified. They include exchanges of signals provided by the specification (protocol) of the interface and signals not provided by (and hence violating) the interface specification.

Techniques for generating test patterns have been developed to date (see, inter alia, Patent Document 1: Jpn. Pat. Appln. Laid-Open Publication No. 9-91315 and Patent Document 2: Jpn. Pat. Appln. Laid-Open Publication No. 6-231063). The most primitive test pattern generation technique is a technique of manually generating a test pattern on the basis of the applicable interface specification. Techniques for creating a verifier communication model by converting the interface specification into a finite state machine (FSM) and subsequently automatically generating a test pattern by means of the technique described in Non-Patent Document 1 (J. Yuan, K. Albin, A. Aziz and C. Pixley, “Constraint Synthesis for Environment Modeling in Functional Verification”, in Proc. Design Automation Conference, pp. 296-299, 2003) are known. This sort of approach is suitable for creating a verifier communication model by generating a test pattern for normal operations provided by the applicable interface specification or a test pattern for expected abnormal operations.

Known techniques that relate to the present invention include those for creating an FSM from a timing chart (see, inter alia, Non-Patent Document 2: K. Ara and K. Suzuki, “A proposal for Transaction-Level Verification with Component Wrapper Languate”, in Process. Design Automation and Test in Europe Conference, pp. 82-87, 2003 and Non-Patent Document 3: K. Ara and K. Suzuki, “Fine-Grained Transaction-Level Verification: Using a Variable Transactor for Improved Coverage at the Signal Level”, In IEEE Trans. on Computer-Aided Design of Integrated Circuits and Systems, vol. 24, no. 8, pp. 1234-1240, August 2005.

However, it is not possible to create a verifier communication model for creating a test pattern that is not expected in the applicable interface specification by means of any of the state of art techniques. To date, such test patterns have been created manually. While manual creation provides a high degree of freedom, the efficiency of the operation of creating a test pattern is very low. Additionally, a scheme for not only inputting normal test patterns and abnormal test patterns but also inputting abnormal test patterns into normal test patterns is required when verifying the interface of hardware.

### SUMMARY OF THE INVENTION

In view of the above-identified problems, it is therefore the object of the present invention to provide a medium storing a model creation program for creating a model for communicating with an object apparatus to be verified, a model creation apparatus and a model creation method.

In the first aspect of the present invention, the above object is achieved by providing a medium storing a model creation program for causing a computer to create a model for communicating with an object apparatus to be verified so as to be readable to the computer, the program causing the computer to execute: an acquisition step that acquires a first finite state machine expressing the interface specification of the object apparatus to be verified as a finite state machine; a first addition step that adds an error state and a state transition to the error state to the first finite state machine to produce a second finite state machine and sets the transition conditions of the second transition machine according to the set error probability; and a conversion step that converts the second finite state machine into a model for communicating with the object apparatus to be verified.

In the second aspect of the present invention, there is provided a model creation apparatus for creating a model adapted to communicate with an object apparatus to be verified, or an object of verification, the apparatus including: an acquisition section that acquires a first finite state machine expressing the interface specification of the object apparatus to be verified as a finite state machine; a first addition step section adds an error state and a state transition to the error state to the first finite state machine to produce a second finite state machine and sets the transition conditions of the second transition machine according to the set error probability; and a conversion section that converts the second finite state machine into a model for communicating with the object apparatus to be verified.

In the third aspect of the present invention, there is provided a model creation method for creating a model adapted to communicate with an object apparatus to be verified, or an object of verification, the method including: an acquisition step that acquires a first finite state machine expressing the interface specification of the object apparatus to be verified as a finite state machine; a first addition step that adds an error state and a state transition to the error state to the first finite state machine to produce a second finite state machine and sets the transition conditions of the second transition machine according to the set error probability; and a conversion step that converts the second finite state machine into a model for communicating with the object apparatus to be verified.

Thus, according to the present invention, it is possible to create a model for communicating with an object apparatus to be verified that can be used to do tests not expected in the applicable interface specification.

### BRIEF DESCRIPTION OF THE DRAWINGS

FIG. 1 is a schematic block diagram of Embodiment 1 of the present invention that is a verifier communication model creation apparatus, illustrating an exemplar configuration thereof;

FIG. 2 is a flowchart of an exemplar operation of the verifier communication model creation apparatus according to Embodiment 1;

FIG. 3 is a schematic block diagram of an exemplar interface specification according to Embodiment 1;

FIG. 4 is a timing chart for an exemplar interface specification according to Embodiment 1;

FIG. 5 is an FSM showing an exemplar interface specification according to Embodiment 1;

FIG. 6 is a table of exemplar transition conditions and exemplar output signals before a transition adding process according to Embodiment 1;

FIG. 7 is an exemplar FSM of Embodiment 1 when an error state is added;

FIG. 8 is a table of exemplar error probabilities according to Embodiment 1;

FIG. 9 is a table of exemplar transition conditions and exemplar output signals after a transition adding process according to Embodiment 1;

FIG. 10 is a description showing part of the verifier communication model of Embodiment 1 when no error transition is added;

FIG. 11 is a description showing part of the verifier communication model of Embodiment 1 when error transitions are added;

FIG. 12 is a description showing part of the verifier communication model of Embodiment 1 when a coverage collection mechanism is added;

FIG. 13 is a table of an exemplar scoreboard according to Embodiment 1;

FIG. 14 is a table of exemplar results of the scoreboard of FIG. 13 according to Embodiment 1;

FIG. 15 is a schematic block diagram according to Embodiment 2 of the present invention that is a verifier communication model creation apparatus, illustrating an exemplar configuration thereof;

FIG. 16 is an exemplar flowchart of the operation of the verifier communication model creation apparatus according to Embodiment 2;

FIG. 17 is an FSM showing an exemplar interface specification according to Embodiment 2;

FIG. 18 is a table of exemplar transition conditions and exemplar output signals before a transition adding process according to Embodiment 2;

FIG. 19 is a table of exemplar test requirements according to Embodiment 2;

FIG. 20 is an exemplar FSM of Embodiment 2 when error states are added;

FIG. 21 is a table of exemplar error probabilities according to Embodiment 2;

FIG. 22 is a table of exemplar transition conditions and exemplar output signals after a transition adding process according to Embodiment 2;

FIG. 23 is a table of an exemplar scoreboard according to Embodiment 2; and

FIG. 24 is a schematic block diagram illustrating a typical connection between the object hardware to be verified and the verifier communication hardware.

### DETAILED DESCRIPTION OF THE PREFERRED EMBODIMENTS

Now, the present invention will be described in greater detail by referring to the accompanying drawings that illustrate preferred embodiments of the invention.

### Embodiment 1

Firstly, the configuration of a verifier communication model creation apparatus (model creation apparatus) of this embodiment will be described.

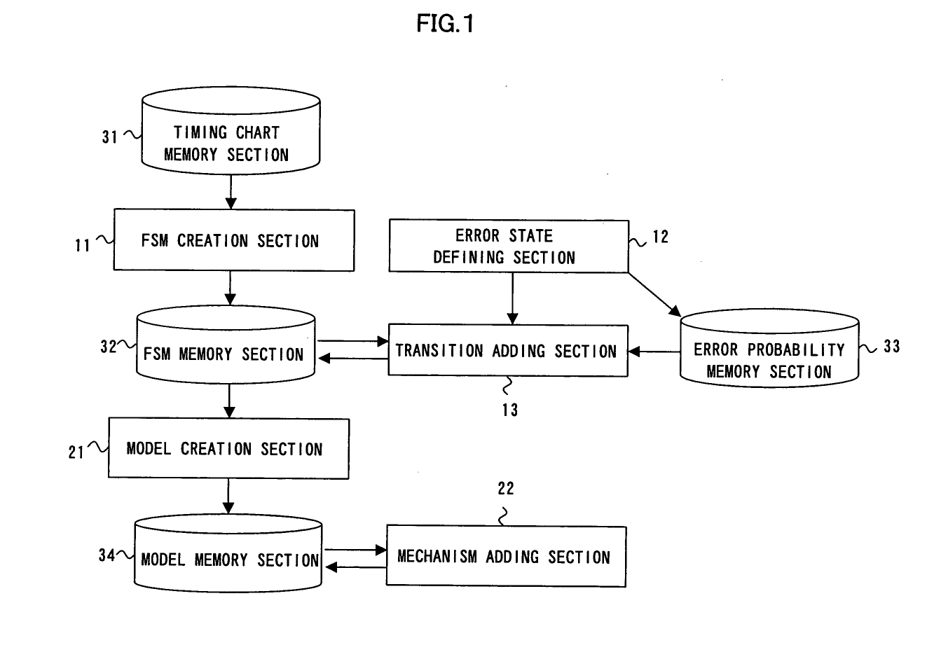

FIG. 1 is a schematic block diagram of the verifier communication model creation apparatus of this embodiment, illustrating an exemplar configuration thereof. Referring to FIG. 1, the verifier communication model creation apparatus is realized by means of an information processing apparatus and comprises an FSM creation section 11, an error state defining section 12, a transition adding section 13, a model creation section 21 and a mechanism adding section 22, which are realized by the control unit of the information processing apparatus, along with a timing chart memory section 31, an FSM memory section 32, an error probability memory section 33 and a model memory section 34, which are realized by a memory device of the information processing apparatus.

Now, the operation of the verifier communication model creation apparatus of this embodiment will be described below.

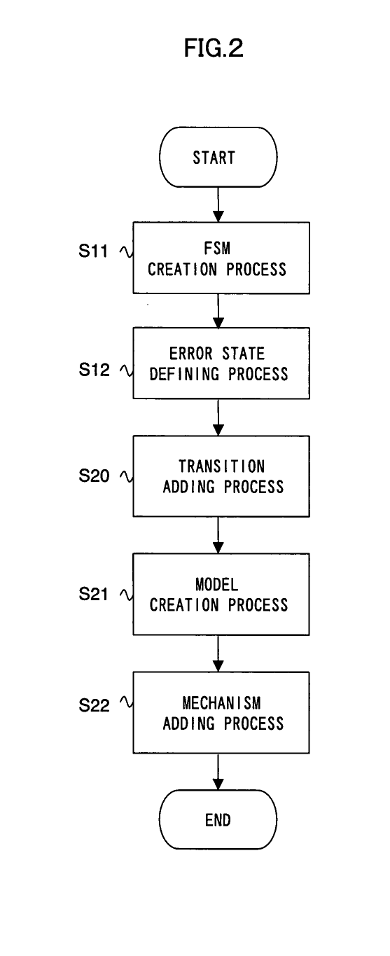

FIG. 2 is a flowchart of an exemplar operation of Embodiment 1 of the verifier communication model creation apparatus. The timing chart memory section 31 stores in advance the timing chart of the interface specification (protocol specification) of the object hardware to be verified (object apparatus to be verified). Then, the FSM creation section 11 executes an FSM creation process of creating an FSM from the timing chart stored in the timing chart memory section 31 and storing it in the FSM memory section 32 (S11). Thereafter, the error state defining section 12 executes an error state defining process of defining an error state (S12).

Subsequently, the transition adding section 13 executes a transition adding process of adding a transition to the error state defined by the error state defining process to the FSM stored in the FSM memory section 32 and storing it in the FSM memory section 32 (S20). Then, the model creation section 21 executes a model creation process of creating a verifier communication model from the FSM stored in the FSM memory section 32 and storing it in the model memory section 34 (S21).

Thereafter, the mechanism adding section 22 executes a mechanism adding process of adding a coverage collection mechanism (recording mechanism) to the verifier communication model stored in the model memory section 34 and storing it in the model memory section 34 (S22) to end the flow of operation.

Now, the operation of the verifier communication model creation apparatus of this embodiment will be described in detail below by way of an exemplar interface specification.

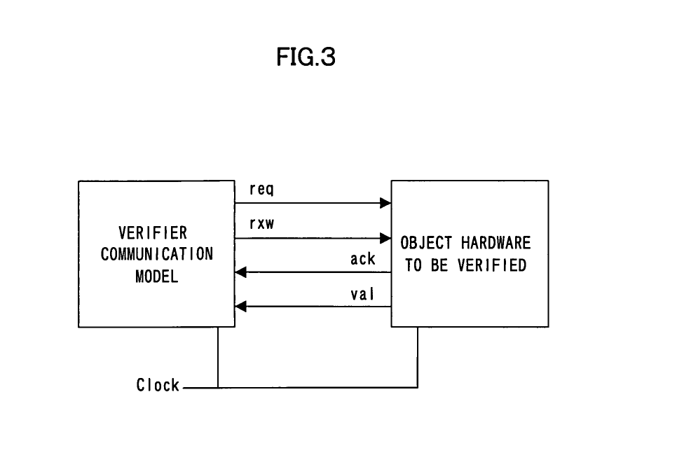

FIG. 3 is a schematic block diagram of an exemplar interface specification of Embodiment 1. Signal Clock is externally input to both the verifier communication model created by the verifier communication model creation apparatus and the object hardware to be verified. Signals req and rxw output from the verifier communication model are input to the object hardware to be verified. Signals ack and val output from the object hardware to be verified are input to the verifier communication model.

Now, the FSM creation process will be described below.

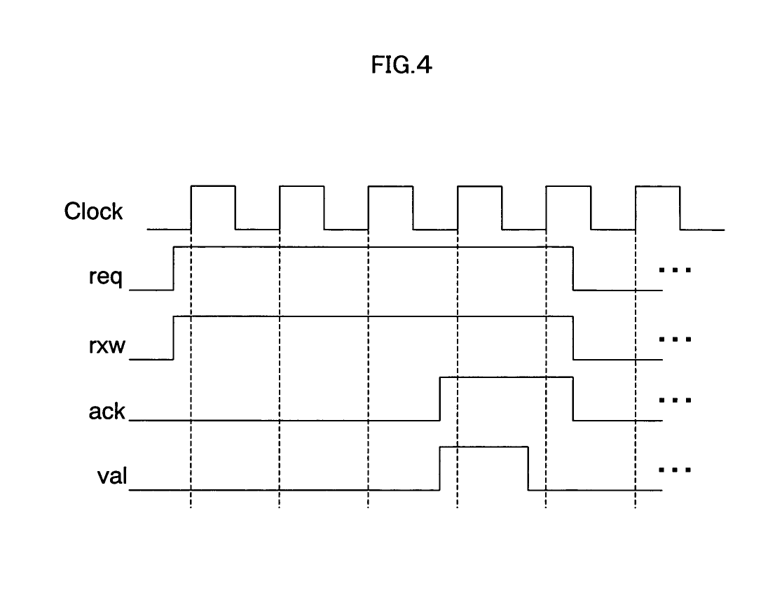

An interface specification is normally expressed as a waveform (timing chart). FIG. 4 is a timing chart for an exemplar interface specification of this embodiment. The timing chart shows five signal waveforms. The signal waveforms are those of the signals Clock, req, rxw, ack and val from above. The values of the four signals req, rxw, ack and val are decided at a rising edge of the signal Clock. The FSM creation section 11 converts the timing chart into an FSM by way of an FSM creation process and stores the FSM in the FSM memory section 32. The FSM creation process can be realized with ease by means of the techniques of the Non-Patent Documents 2 and 3.

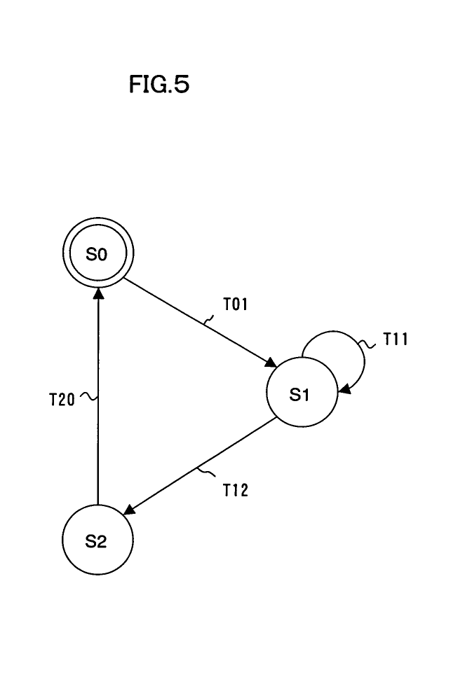

FIG. 5 is an FSM showing an exemplar interface specification of this embodiment. It shows an FSM obtained from the timing chart of FIG. 4. The states of the FSM are determined by the values of the four signals req, rxw, ack and val.

The initial state of the FSM is state S0. Transition T01 to state S1 takes place to state S0 when transition condition a is satisfied. The state S1 does not show any transition (or transition T11 to state S1 takes place) when transition condition b is satisfied but transition T12 to state S2 takes place when transition condition c is satisfied.

Transition T20 to state S0 takes place to state S2 when transition condition d is satisfied.

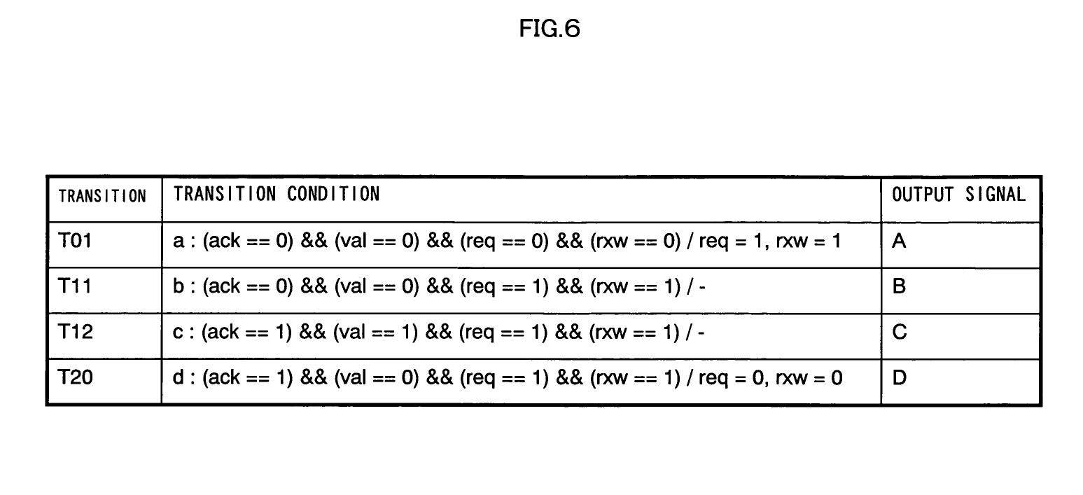

FIG. 6 is a table of exemplar transition conditions and exemplar output signals before a transition adding process of this embodiment. Assume that the transition conditions of transitions T01, T11, T12 and T20 are respectively a, b, c and d. The transition conditions a, b, c and d are expressed by using values of signals req, rxw, ack and val. Also assume that the output signals (test patterns) output from the verifier communication model to the object hardware to be verified for transitions T01, T11, T12 and T20 are A, B, C and D respectively.

Now, the error state defining process will be described below.

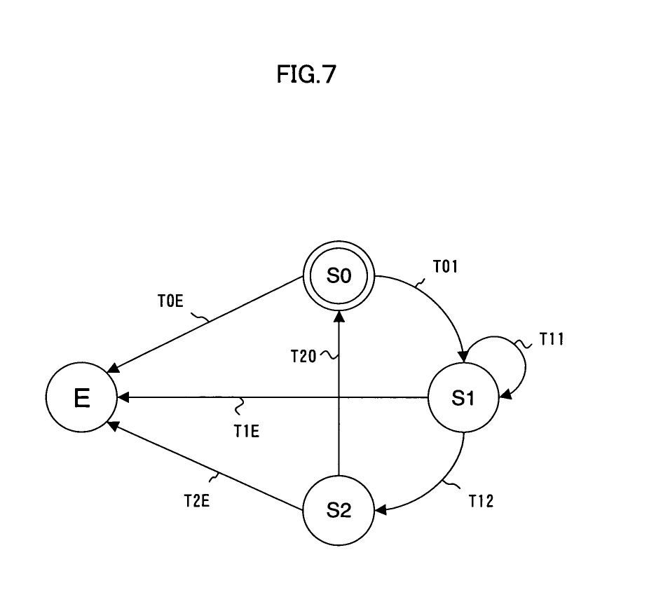

In this embodiment, the error state defining section 12 defines an error state E. However, the error state defining section 12 may alternatively define a plurality of error states or randomly define one or more error states. FIG. 7 shows an exemplar FSM of this embodiment when an error state is added. In this embodiment, error transition T0E from state S0 to error state E, error transition T1E from state S1 to error state E and error transition T2E from state S2 to error state E are added.

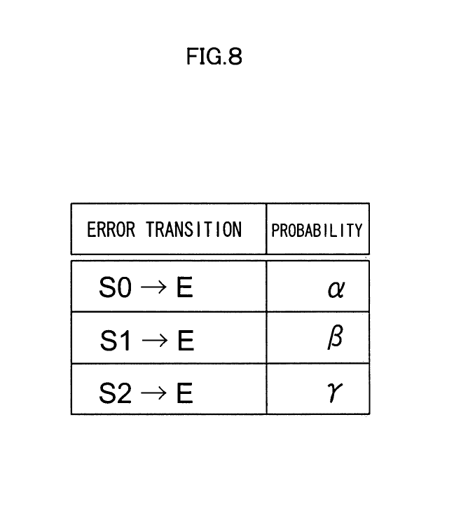

Then, the error state defining section 12 selects and sets the error probabilities that are the probabilities with which those error transitions respectively take place. More specifically, the error state defining section 12 receives the input of the probability of each error transition from the user (verifier) and then stores it in the error probability memory section 33. Then, the error state defining section 12 selects and sets the input error probabilities and stores them in the error probability memory section 33 as error probability table. FIG. 8 is a table of exemplar error probabilities of this embodiment. In the error probability table, the error probability a of error transition T0E (S0→E), the error probability β of error transition T1E (S1→E) and the error probability γ of error transition T2E (S2→E) are set.

With this error state defining process, it is possible to automatically create a transition from a normal state to an error state. Additionally, the user can control transition probabilities to an error state and hence can conduct an appropriate test.

Now, the transition adding process will be described below.

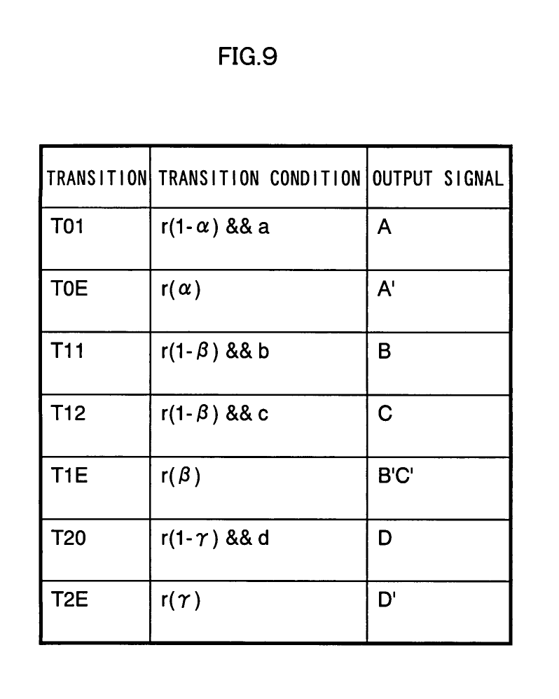

The transition adding section 13 adds the error transitions from the individual states and, at the same time, corrects the normal transitions. FIG. 9 is a table of exemplar transition conditions and exemplar output signals after a transition adding process of this embodiment. The transition conditions set by the transition adding process are expressed by means of the original transition conditions a, b, c and d, the error probabilities a, β, and γ and a function r(x). Note that the function r(x) is a function that becomes true with probability x. The output signals set by the transition adding process are expressed by means of the original output signals A, B, C and D.

Firstly, the transition adding section 13 adds transition T0E from state S0 and corrects the transition T01. Assume that the transition condition of error transition T0E is r(a). On the other hand, the transition condition of transition T01 is that error transition T0E does not take place and the original transition condition a is satisfied and hence it is expressed by (r(1−a) && a). Note that the output signal for error transition T0E is the logical NOT, or A′, of the output signal A for normal transition T01. Similarly, the transition adding section 13 selects and sets the transition conditions and the output signals of transitions T11, T12, T1E, T20 and T2E.

With this transition adding process, it is possible to create an FSM that transits into an error state with the set error probabilities.

Now, the model creation process will be described below.

The model creation section 21 converts the FSM to which error transitions are added as a result of an transition adding process into a verifier communication model that is described in a hardware description language or a general purpose programming language and stores the model in the model memory section 34 as a verifier communication model. Now, both a verifier communication model created when no error transition is added and a verifier communication model creased when error transitions are added will be described below. The model is described in hardware simulation language Verilog (tradename)-HDL in the following instance.

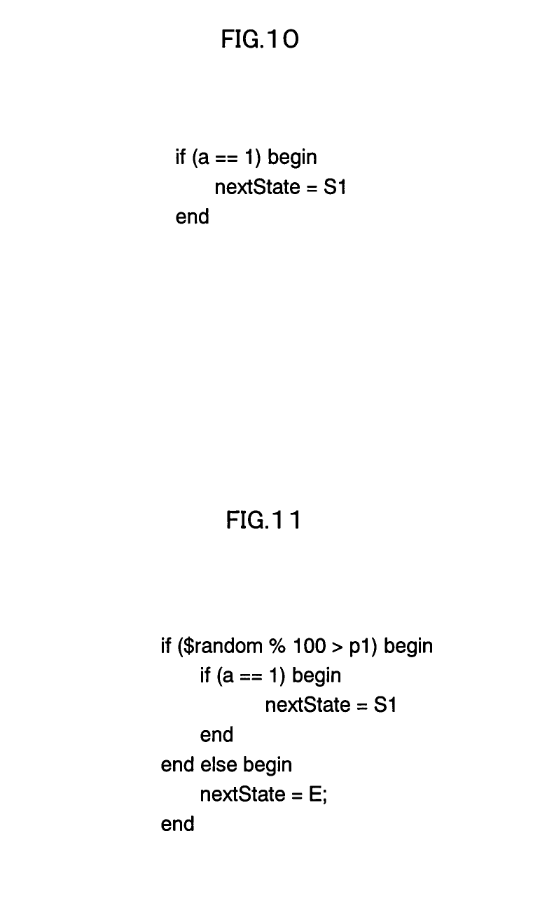

FIG. 10 is a description showing part of the verifier communication model of this embodiment when no error transition is added. More specifically, FIG. 10 illustrates a part that shows state S0 of the verifier communication model when no error transition is added. The model moves into state S1 when the transition condition a is satisfied in state S0.

FIG. 11 is a description showing part of the verifier communication model of his embodiment when error transitions are added. More specifically, FIG. 11 illustrates a part that shows state S0 of the verifier communication model when error transitions are added. The error probability a is expressed by p1 [%]. The model moves into state E (T0E) when a random number satisfies the error probability p1 in state S0. On the other hand, the model moves into state S1 (T01) when, a random number does not satisfy the error probability p1 in state S0 and the original transition condition a is satisfied. ($random % 100) outputs an integer random number between 0 and 99. The model makes a determination on the transition conditions in normal operations when the value is larger than p1 [%], whereas it makes an error transition when the value is not larger than p1 [%].

With this model creation process, it is possible to create a verifier communication model that transits into an error state with a set error probability.

Now, the mechanism adding process will be described below.

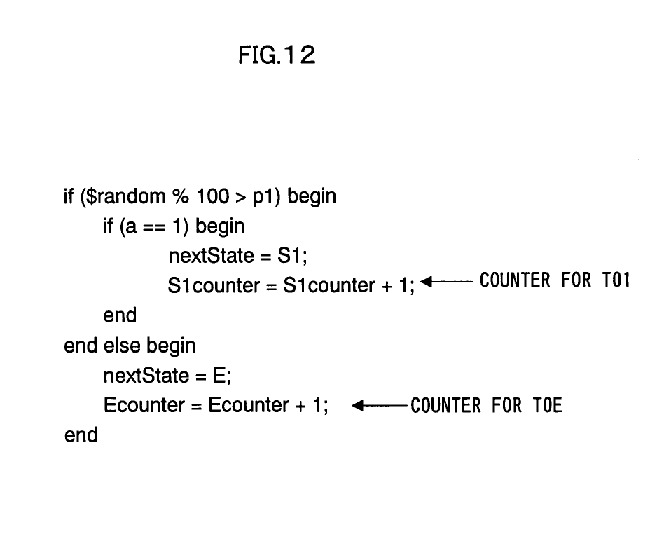

The mechanism adding section 22 adds a coverage collection mechanism to the transition part of the verifier communication model created by the model creation process. The coverage collection mechanism counts the number of times of passage of each transition and outputs it. FIG. 12 is a description showing part of the verifier communication model of this embodiment when a coverage collection mechanism is added. A coverage collection mechanism is added to the model of FIG. 11. In this model, the part denoted by counter for T01 is the counter that counts the number of times of passage of transition T01, whereas the part denoted by counter for T0E is the counter that counts the number of times of passage of transition T0E. Furthermore, the mechanism adding section 22 adds an initialization part that initializes each counter reading to 0 and a scoreboard output part that outputs each counter reading as scoreboard to the verifier communication model.

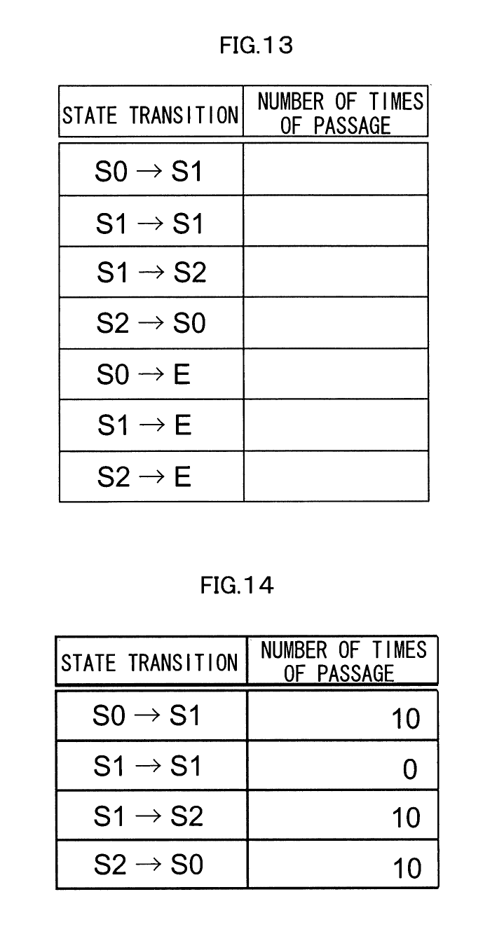

All the state transitions in the FSM are listed up in the scoreboard and the number of times of each state transition is recorded there. FIG. 13 is a table of an exemplar scoreboard of this embodiment. It shows the number of times of passage of each of all the error transitions (T0E, T1E, T2E) are recorded in the scoreboard in addition to the number of times of passage of each of all the transitions (T01, T11, T12, T20) according to the interface specification.

FIG. 14 is a table of exemplar results of the scoreboard of FIG. 13 of this embodiment. This scoreboard shows the data recorded by the coverage collection mechanism as a result of a test conducted by using the verifier communication model and the object hardware to be verified. Note that only four state transitions (S0→S1), (S1→S1), (S1→S2) and (S2→S0) are used here for the purpose of simplicity of explanation. According to the scoreboard, there is not less than one passages of state transition of each of all the state transitions except the state transition from state S1 to state S1. Thus, the scoreboard shows that the ratio of the state transition coverage of the test is 75%.

A test tool can conduct a test by using the verifier communication model created by this verifier communication model creation apparatus and the object hardware to be verified. The test tool can acquire the degree of sufficiency of the test by means of a scoreboard and can conduct one or more additional tests or terminate the test according to the degree of sufficiency.

The verifier communication model creation apparatus may reset the error probabilities, for example, by raising the error probability of each error transition whose number of times of passage is small according to the scoreboard. It may allow a test tool to access the error probability table so that the test tool may reset the error probabilities according to the scoreboard and repeat the test.

With this mechanism adding process, the user can know the number of times of passage of each and every state transition, the number of times of output of each and every test pattern and so on. Then, as a result, the test tool and the user can see the degree of sufficiency of each test.

Thus, it is possible to test the error processing capabilities of the object hardware to be verified such as if the object hardware to be verified can appropriately cope with a situation where a transition to an error state takes place by using the verifier communication model created by this embodiment.

### Embodiment 2

A verifier communication model creation apparatus adapted to create a verifier communication mode that outputs a test pattern according to test requirements will be described in the following description of this embodiment.

The verifier communication model created by the verifier communication model creation apparatus of Embodiment 1 makes a transition to an error state only once. In other words, this verifier communication model outputs an abnormal test pattern only once and thereafter it no longer outputs any abnormal test pattern. Such a test may be not appropriate depending on the case of testing the interface of hardware. Examples of such cases may include a case where it is desirable to output an abnormal test pattern only in a specific test and a case where it is desirable to output an abnormal test pattern and immediately thereafter a normal test pattern.

Firstly the configuration of the verifier communication model creation apparatus of this embodiment will be described below.

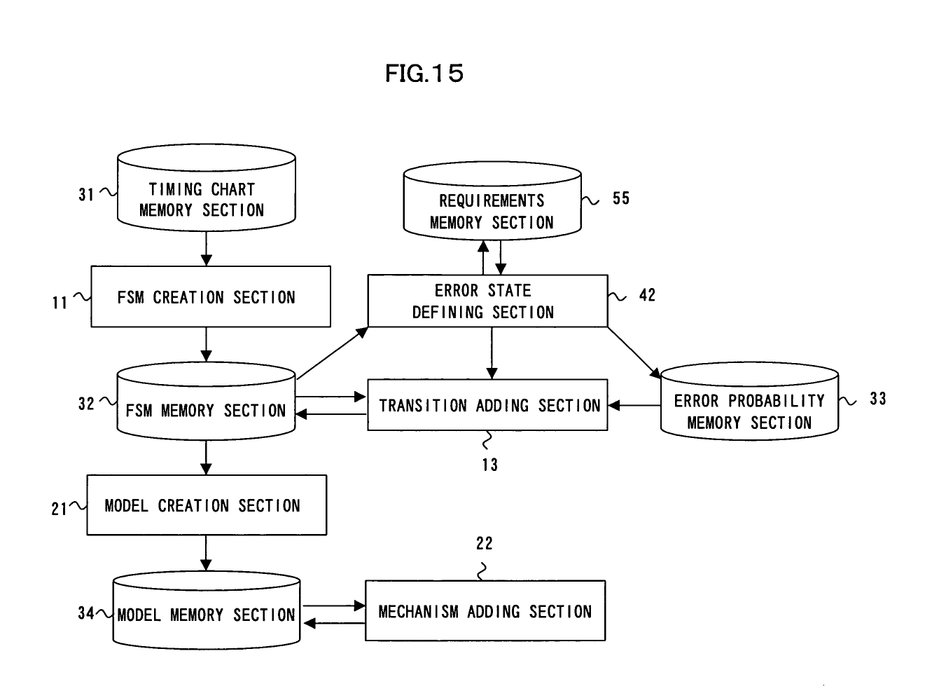

FIG. 15 is a schematic block diagram of the verifier communication model creation apparatus of this embodiment, illustrating an exemplar configuration thereof. In FIG. 15, the components same as those of FIG. 1 are denoted respectively by the same reference symbols and will not be described here any further. By comparing FIG. 15 with FIG. 1, it will be seen that this embodiment comprises an error state defining section 42 instead of the error state defining section 12 of Embodiment 1 and additionally a requirements memory section 55. The error state defining section 42 is realized by the control unit of an information processing apparatus and the requirements memory section 55 is realized by a memory device of the information processing apparatus.

Now, the operation of the verifier communication model creation apparatus of this embodiment will be described below.

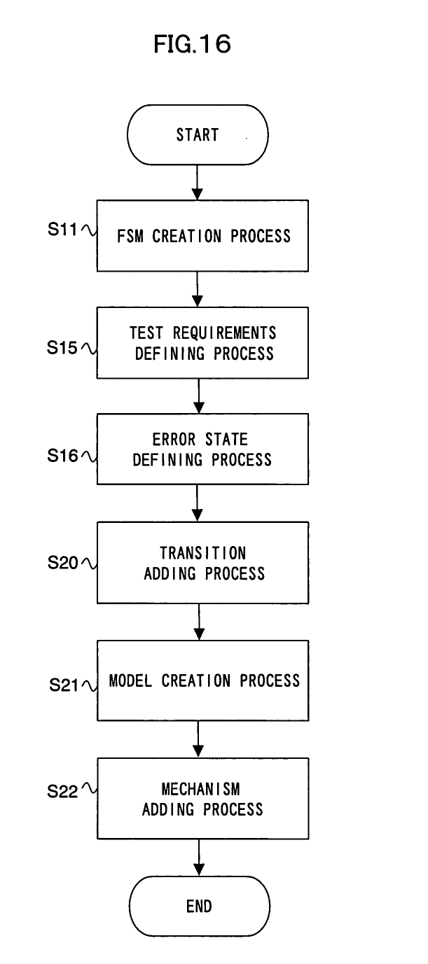

FIG. 16 is an exemplar flowchart of the operation of Embodiment 2 of the verifier communication model creation apparatus. In FIG. 16, the reference symbols same as those of FIG. 2 denote processes that are same as or similar to those of FIG. 2 and hence those processes will not be described here any further. By comparing FIG. 16 with FIG. 2, it will be seen that the process S12 of FIG. 2 is replaced by processes S15 and S16.

After the process S11 is executed as in Embodiment 1, the error state defining section 42 sets test requirements and executes the test requirements defining process stored in the requirements memory section 55 (S15). Then, the error state defining section 42 executes an error state defining process for defining an error state for partial FSM so as to satisfy the test requirements (S16). Thereafter, the processes S20, S21, S22 are executed as in Embodiment 1.

Now, the operation of the verifier communication model creation apparatus of this embodiment will be described in detail below by way of an exemplar interface specification.

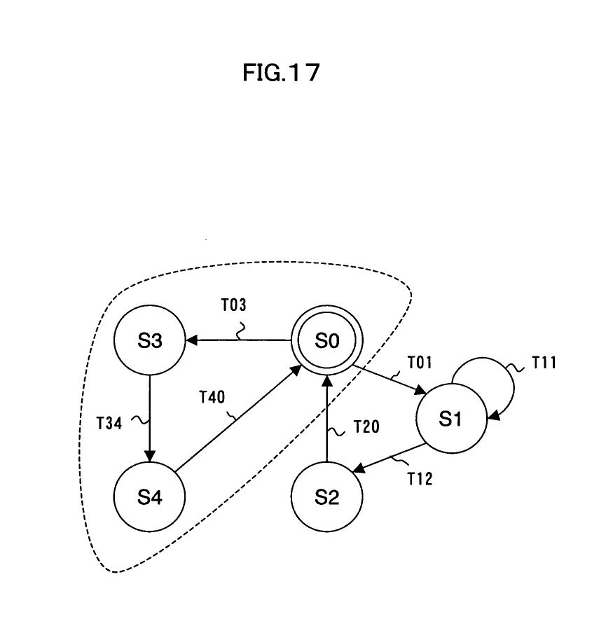

FIG. 17 is an FSM showing an exemplar interface specification of this embodiment. This FSM additionally has states S3 and S4 as well as transition T03 from state S0 to state S3, transition T34 from state S3 to state S4 and transition T40 from state S4 to state S0. Transactions according to the interface specification will be described here. In FIG. 17, there exist a route starting from initial state S0 and returning to state S0 by way of states S1 and S2 and another route starting from initial state S0 and returning to state S0 by way of states S3 and S4. Transactions refer to these routes and correspond to partial FSM in the FSM. For example, the transaction having the route of states S0, S1 and S2 refers to a data write transaction, whereas the transaction having the route of states S0, S3 and S4 refers to a data read transaction.

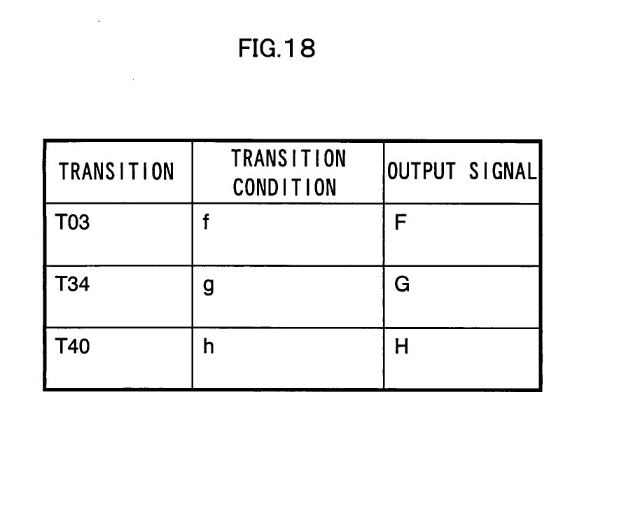

FIG. 18 is a table of exemplar transition conditions and exemplar output signals before a transition adding process of this embodiment. Assume that the transition conditions of transitions T03, T34 and T40 are respectively f, g and h. Also assume that the output signals (test patterns) output from the verifier communication model to the object hardware to be verified in transitions T03, T34 and T40 are respectively F, G and H.

Now, the test requirements defining process will be described below.

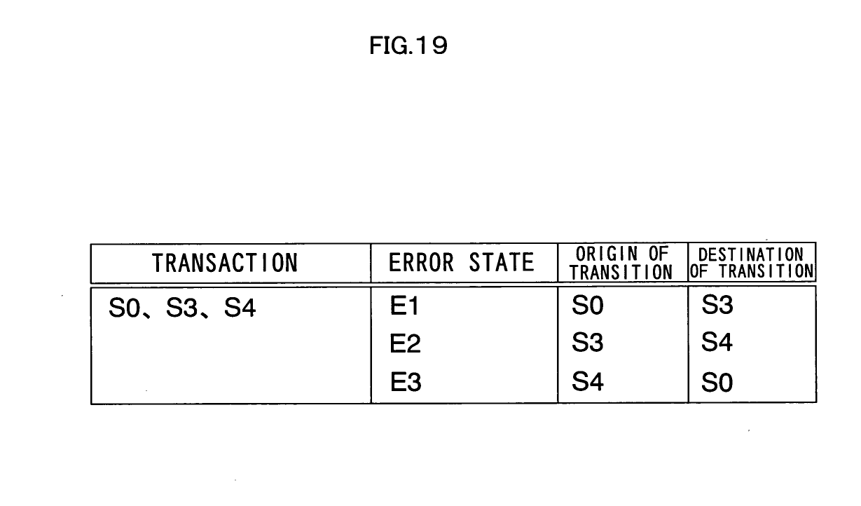

The error state defining section 42 receives an input of test requirements from the user and stores it in the requirements memory section 55. Test requirements specify the transactions for outputting an error according to the interface specification, the types of error states to be added, the state of the origin of transition that can make a transition to an error state in specific transactions and so on. If the error state defining section 42 defines a plurality of error states, test requirements specify the error state of the destination of transition. FIG. 19 is a table of exemplar test requirements of this embodiment. The test requirements include the transactions of the above-described partial FSM, the newly defined error state or states, the state of the origin of transition and the state of the destination of transition. Assume here that the transaction having the route of states S0, S3 and S4 is the partial FSM. An error state is defined for each state of the origin of transition. Error states include error state E1 to which a transition can be made from state S0, error state E2 to which a transition can be made from state S3 and error state E3 to which a transition can be made from state S4. Error state E1 makes a transition to state S3 and error state E2 makes a transition to state S4, while error state E3 makes a transition to state S0.

Now, the error state defining process will be described below.

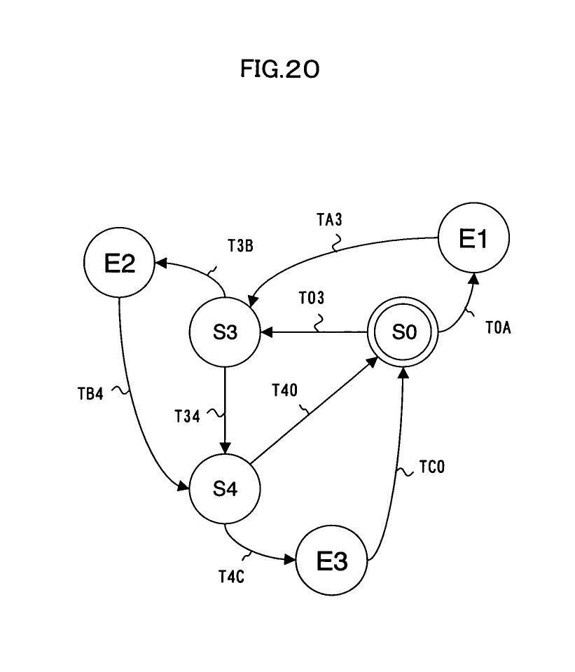

The error state defining section 42 defines error states according to the test requirements stored in the requirements memory section 55. FIG. 20 is an exemplar FSM of this embodiment when an error state is added. Transition T0A from state S0 to error state E1, transition TA3 from error state E1 to state S3, transition T3B from state S3 to error state E2, transition TB4 from error state E2 to state S4, transition T4C from state S4 to error state E3 and transition TC0 from error state E3 to state S0 are added according to the test requirements.

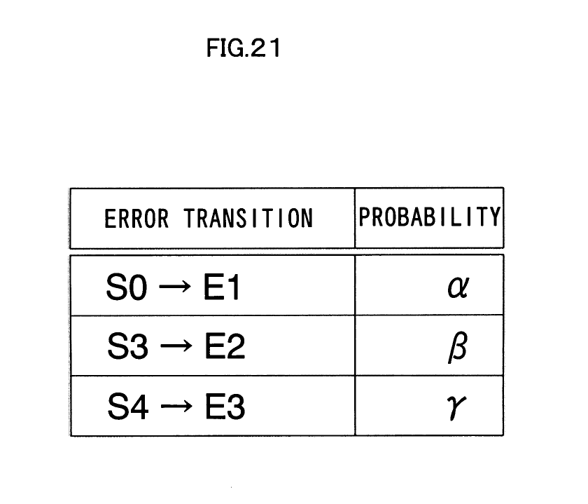

Then, the error state defining section 42 sets the error probabilities that are the probabilities with which transitions T0A, T3B and T4C to error states E1, E2 and E3 take place respectively. More specifically, the error state defining section 42 receives the input of the error probability of each error transition and stores it in the error probability memory section 33. Then, the error state defining section 42 sets the input error probabilities and stores them in the error probability memory section 33 as error probability table. FIG. 21 is a table of exemplar error probabilities of this embodiment. In the error probability table, the error probability a with which error transition T0A (S0→E1) takes place, the error probability β with which error transition T3B (S3→E2) takes place and the error probability γ with which error transition T4C (S4 E3) takes place are set in the error probability table.

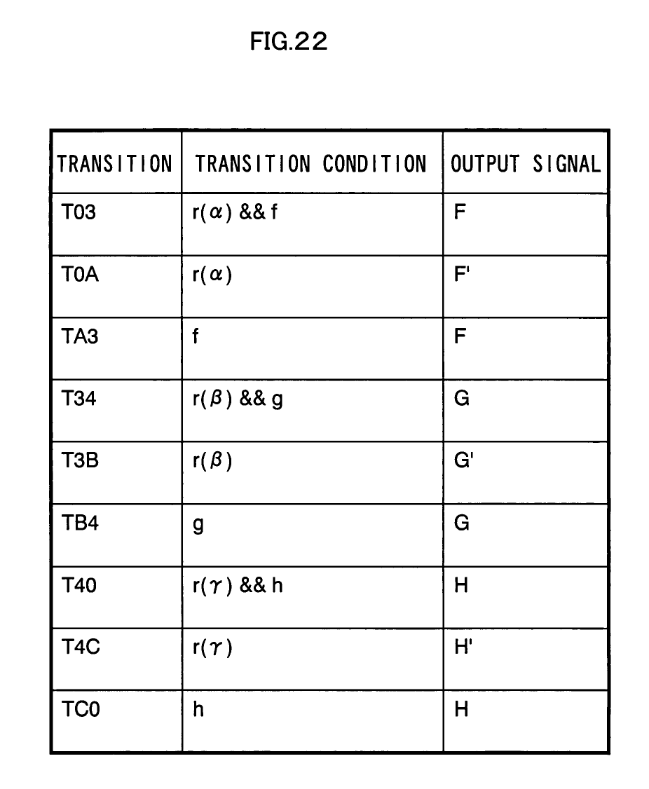

FIG. 22 is a table of exemplar transition conditions and exemplar output signals after a transition adding process of this embodiment. The transition conditions set by the transition adding process are expressed by the original transition conditions f, g and h, the error probabilities a, β and γ and a function r(x). The output signals set by the transition adding process are expressed by means of the original output signals F, G and H.

With the test requirements defining process and the error state defining process as described above, it is possible to create a verifier communication model that generates errors in specific transactions in the interface specification. It is also possible to automatically create state transitions that satisfy the test requirements.

Now, the mechanism adding process will be described below.

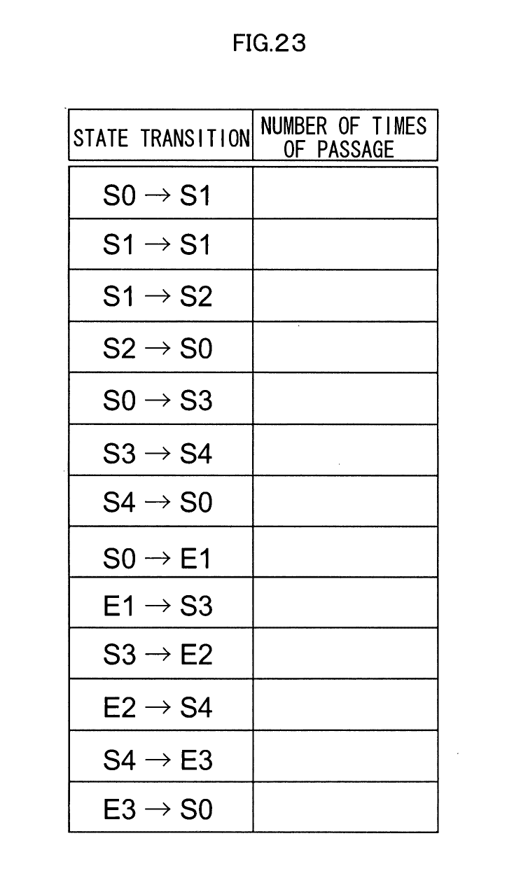

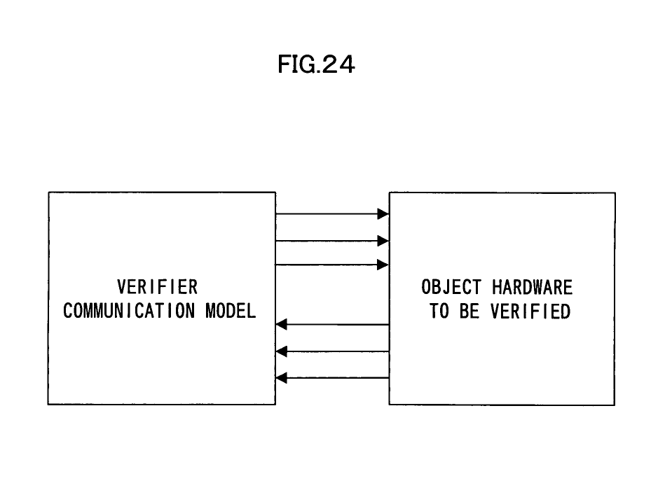

FIG. 23 is a table of an exemplar scoreboard of this embodiment. The number of times of passage is recorded for all the transitions that can take place. While the coverage collection mechanism of this embodiment records the number of times of passage of each state transition in the above description, it may alternatively be so arranged that the coverage collection mechanism records the number of times of passages of each transaction. If such is the case, the scoreboard lists not only the transactions specified as partial FSM but also all the routes that pass through an error state somewhere on the routes of the partial FSM.

Thus, it is possible to test with ease the ability of withstanding errors of the object hardware to be verified such as if the object hardware to be verified can restore the normal state when a transition to an error state takes place by using a verifier communication model created by this embodiment.

The acquisition step corresponds to the error state defining process and the test requirements defining process of the above-described embodiments. The first addition step corresponds to the transition adding process of the embodiments. The conversion step corresponds to the model creation process of the embodiments. The second addition step corresponds to the mechanism adding process of the embodiments. The specification conversion step corresponds to the FSM creation process of the embodiments.

The acquisition section corresponds to the error state defining section of the embodiments. The first addition section corresponds to the transition adding section of the embodiments. The conversion section corresponds to the model creation section of the embodiments. The second addition section corresponds to the mechanism adding section of the embodiments. The specification conversion section corresponds to the FSM creation section of the embodiments.

The embodiments of model creation apparatus can easily find applications in information processing apparatus to raise the performance of the information processing apparatus. Information processing apparatus to which the present invention is applicable include PCs (personal computers), servers and work stations.

It is possible to provide a program for causing the computer that operates as model creation apparatus to execute the above-described steps. It is possible to cause a computer that operates as model creation apparatus to execute the program by storing it in a computer-readable recording medium. Computer readable recording mediums that can be used for the purpose of the present invention include portable storage mediums such as CD-ROMs, flexible disks, DVDs, magneto-optic disks and IC cards, data bases adapted to hold computer programs, other computers, the data bases of such computers and transmission mediums on communication lines.

What is claimed is:

1. A medium storing a model creation program for causing a computer to create a model for communicating with an object apparatus to be verified so as to be readable to the computer, the program causing the computer to execute:
an acquisition step that acquires a first finite state machine expressing the interface specification of the object apparatus to be verified as a finite state machine;
a first addition step that adds an error state and a state transition to the error state to the first finite state machine to produce a second finite state machine and sets the transition conditions of the second transition machine according to the set error probability; and
a conversion step that converts the second finite state machine into a model for communicating with the object apparatus to be verified.

2. The medium storing a model creation program according to claim 1, the program causing the computer to further execute:
a second addition step that adds a recording mechanism for taking a record relating to the state transition of passage at the time of the verification to the verifier communication model after the conversion step.

3. The medium storing a model creation program according to claim 2, wherein
the recording mechanism counts the number of times of passage of each state transition of the second finite state machine and outputs the number of times of passage of each state transition.

4. The medium storing a model creation program according to claim 2, wherein
the recording mechanism counts the number of times of passage of each route of state transition of the second finite state machine and outputs the number of times of passage of each route of state transition.

5. The medium storing a model creation program according to claim 1, wherein
the first addition step acquires the error probability of each state transition to the error state.

6. The medium storing a model creation program according to claim 1, wherein
the transition condition of each state transition to the error state is the condition that is satisfied with the error probability.

7. The medium storing a model creation program according to claim 1, wherein
the first addition step acquires the transition condition of the first state transition that is the state transition from the first state in the first finite state machine and alters the transition condition of the first state transition in the second finite state machine according to the transition condition from the first state to the error state.

8. The medium storing a model creation program according to claim 1, wherein
the first addition step acquires the contents of the output signal output from the model to the object apparatus to be verified due to the first state transition from the first state in the first finite state machine and sets the contents of the output signal due to the state transition from the first state to the error state according to the former contents.

9. The medium storing a model creation program according to claim 1, wherein
the acquisition step further acquires part information specifying a part of the first finite state machine, and
the first addition step adds the error state and the state transition to the error state to the first finite state machine for the part of the first finite state machine specified by the part information.

10. The medium storing a model creation program according to claim 1, wherein
the acquisition step further acquires origin of transition information specifying the state in the first finite state machine that can make a transition to the error state, and the first addition step adds the error state and the state transition from the state specified by the origin of transition information to the error state to the first finite state machine.

11. The medium storing a model creation program according to claim 1, wherein
the acquisition step further acquires destination of transition information specifying the state in the first finite state machine that can make a transition from the error state, and
the first addition step adds the error state and the state transition from the error state to the state specified by the destination of transition information to the first finite state machine.

12. The medium storing a model creation program according to claim 1, the program causing the computer to further execute:
a specification conversion step that converts the timing chart expressing the interface specification into a finite state machine expressing the interface specification before the first addition step.

13. The medium storing a model creation program according to claim 1, wherein
the model is expressed by a hardware description language or a programming language.

14. A model creation apparatus for creating a model adapted to communicate with an object apparatus to be verified, or an object of verification, the apparatus comprising:
an acquisition section that acquires a first finite state machine expressing the interface specification of the object apparatus to be verified as a finite state machine;
a first addition step section adds an error state and a state transition to the error state to the first finite state machine to produce a second finite state machine and sets the transition conditions of the second transition machine according to the set error probability; and
a conversion section that converts the second finite state machine into a model for communicating with the object apparatus to be verified.

15. The model creation apparatus according to claim 14, wherein
it further causes a computer to execute a second addition section that adds a recording mechanism for taking a record relating to the state transition of passage at the time of the verification to the verifier communication model.

16. The model creation apparatus according to claim 14, wherein
the transition condition of each state transition to the error state is the condition that is satisfied with the error probability.

17. The model creation apparatus according to claim 14, wherein
the first addition section acquires the transition condition of the first state transition that is the state transition from the first state in the first finite state machine and alters the transition condition of the first state transition in the second finite state machine according to the transition condition from the first state to the error state.

18. The model creation apparatus according to claim 14, wherein
the acquisition section further acquires part information specifying a part of the first finite state machine; and
the first addition section adds the error state and the state transition to the error state to the first finite state machine for the part of the first finite state machine specified by the part information.

19. The model creation apparatus according to claim 14, wherein
it further causes a computer to execute a specification conversion section of converting the timing chart expressing the interface specification into a finite state machine expressing the interface specification.

20. A model creation method for creating a model adapted to communicate with an object apparatus to be verified, or an object of verification, the method comprising:
an acquisition step that acquires a first finite state machine expressing the interface specification of the object apparatus to be verified as a finite state machine;
a first addition step that adds an error state and a state transition to the error state to the first finite state machine to produce a second finite state machine and sets the transition conditions of the second transition machine according to the set error probability; and
a conversion step that converts the second finite state machine into a model for communicating with the object apparatus to be verified.
